(19) United States
(12) Patent Application Publication
(10) Pub. No.: US 2009/0250584 A1
(43) Pub. Date: Oct. 8, 2009

(54) ADJUSTABLE HOLDING DEVICE FOR DRUMS

(75) Inventor: Wu-Hong HSIEH, Lu Chou City (TW)

Correspondence Address: PATENTTM.US, P. O. BOX 82788, PORTLAND, OR, 97282-0788, US

(73) Assignee: K.H.S. MUSICAL INSTRUMENT CO. LTD., Lu Chou City (TW)

(21) Appl. No.: 12/062,436

(22) Filed: Apr. 3, 2008

(51) Int. Cl. G10D 13/02

(52) U.S. Cl. 248/346.06; 84/421

(57) ABSTRACT

An adjustable holding device for drums has a base, a positioning clip and a mounting sleeve. The base has two lower positioning notches and a pivot recess. The positioning clip is connected pivotally to the front end of the base and has an intermediate section and two arms. The arms formed on the intermediate section and are connected pivotally to the base and each arm has an upper positioning notch cooperating with one lower positioning notch to form a positioning hole. The mounting sleeve is mounted pivotally in the pivot recess and has two friction wheels selectively and respectively engaging the positioning holes. The adjustable holding device can adjust the angular position of a supporting rod that holds the drums.

### BACKGROUND OF THE INVENTION

1. Field of the Invention

The present invention relates to a holding device, and more particularly to an adjustable holding device that is mounted on a bass drum and holds a supporting rod supporting a pair of drums such as tom-toms. The adjustable holding device is capable of adjusting the angles of the supporting rods relative to the bass drum so that the drums can be oriented to appropriately face a beater.

2. Description of Related Art

Conventional drum sets have a pair of drums such as tom-toms mounted securely on a bass drum through a bracket and a supporting rod. The bracket is mounted securely on the bass drum. The supporting rod is mounted uprightly on the bracket and supports the drums. With the bracket and the supporting rod, the drums are securely suspended over the bass drum.

However, no angle adjusting devices are set on the bracket or the supporting rod to adjust the orientations and heights of the suspended drums relative to the bass drum. When a beater is too tall or too short to beat the drums he have to unnaturally tilt his upper trunk in to hit the drums. With the unnaturally tilted pose to play the drum set for a period of time, the beater would feel uncomfortable and painful on his waist, back and arms after and even ache.

To overcome the shortcomings, the present invention provides an adjustable holding device for drums to mitigate or obviate the aforementioned problems.

### SUMMARY OF THE INVENTION

The main objective of the invention is to provide an adjustable holding device that is mounted on a bass drum and holds a supporting rod supporting a pair of drums such as tom-toms. The adjustable holding device is capable of adjusting the angles of the supporting rods relative to the bass drum so that the drums can be oriented to appropriately face a beater.

An adjustable holding device for drums in accordance with the present invention comprises a base, a positioning clip and a mounting sleeve. The base has two lower positioning notches and a pivot recess. The positioning clip is connected pivotally to the front end of the base and has an intermediate section and two arms. The arms formed on the intermediate section and are connected pivotally to the base and each arm has an upper positioning notch cooperating with one lower positioning notch to form a positioning hole. The mounting sleeve is mounted pivotally in the pivot recess and has two friction wheels selectively and respectively engaging the positioning holes. The adjustable holding device can adjust the angular position of a supporting rod that holds the drums.

Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of an adjustable holding device in accordance with the present invention mounted on a bass drum and hold a supporting rod supporting two drums such as tom-toms;

FIG. 2 is a perspective view of the adjustable holding device in FIG. 1;

FIG. 3 is a perspective view of the adjustable holding device in FIG. 2;

FIG. 4 is a side view of the adjustable holding device in FIG. 2;

FIG. 5 is a side view in partial section of the adjustable holding device in FIG. 4;

FIG. 6 is an operational side view in partial section of the adjustable holding device in FIG. 5 with the positioning clip pivoting up to release the mounting sleeve; and

FIG. 7 is an operational side view of the adjustable holding device in FIG. 6 with the positioning clip pivoting down to hold the mounting sleeve in a specific angular position.

### DETAILED DESCRIPTION OF THE PREFERRED EMBODIMENT

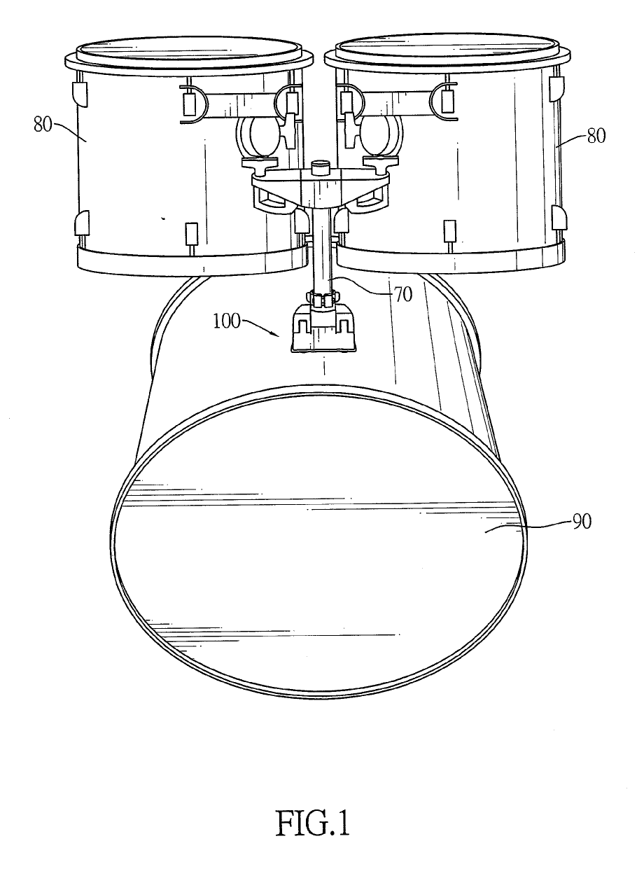

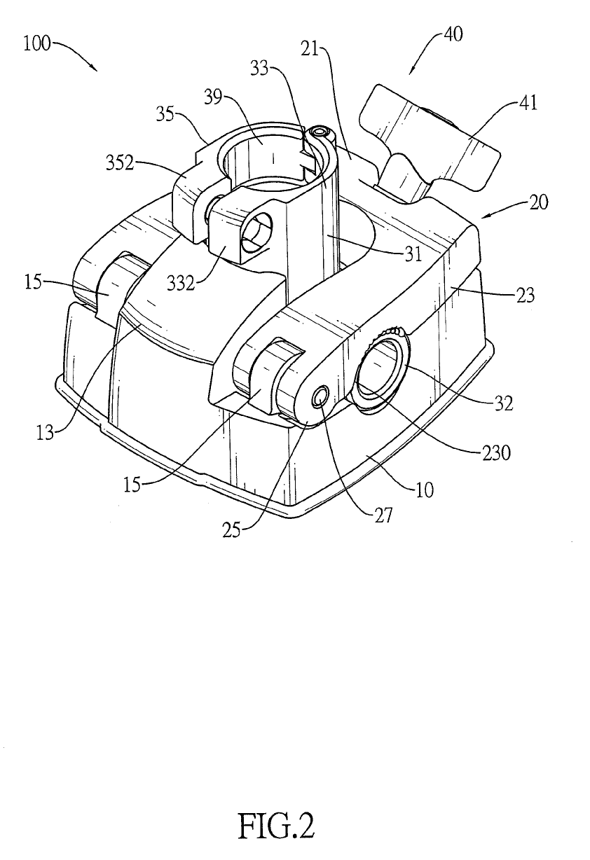

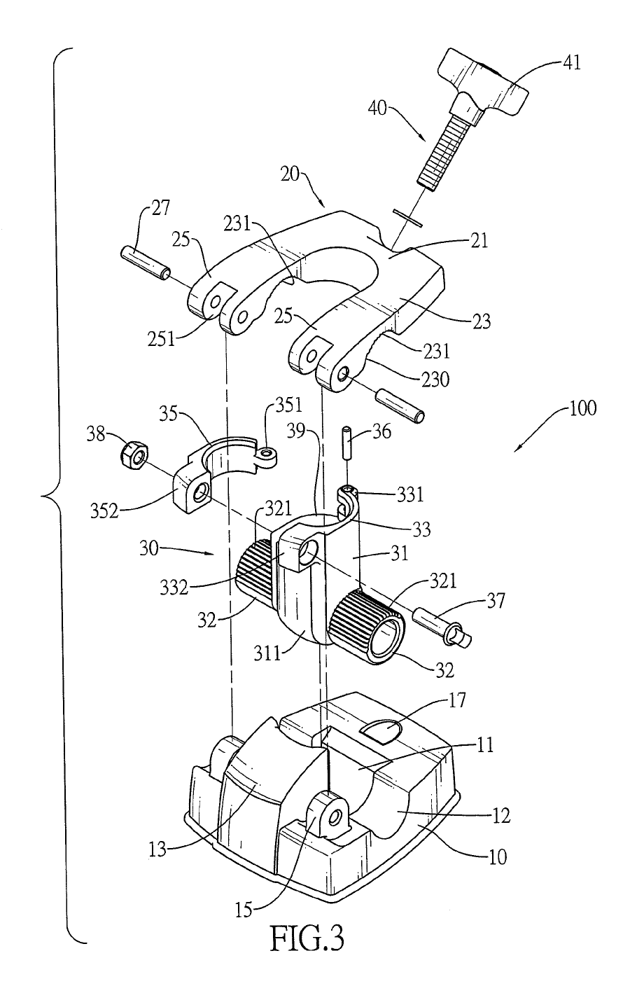

With reference to FIGS. 1 to 3, an adjustable holding device (100) in accordance with the present invention is mounted on the bass drum (90) and holds a supporting rod (70). The bass drum (90) has a sidewall being annular. The supporting rod (70) supports two drums (80) such as tom-toms.

The adjustable holding device (100) comprises a base (10), a positioning clip (20), a mounting sleeve (30) and an adjusting knob.

The base (10) is mounted on the sidewall of the bass drum (90) and has a front end, a rear end, two opposite sides, a top, a bottom, two lower positioning notches (12), a pivot recess (11), two pivot mounts (15) and a mounting hole (17) and may have an angle limit (13).

The lower positioning notches (12) are curved and are defined in the top of the base (10) adjacent respectively to the sides.

The pivot recess (11) is curved and is defined in the top of the base (10) between the lower positioning notches (12) and has an inner surface being curved.

The pivot mounts (15) are formed on the top of the base (10) adjacent respectively to the sides and near the front end and each pivot mount (15) has a pivot hole defined through the pivot mount (15).

The mounting hole (17) is defined obliquely in the top of the base (10) near the rear end and has an inner thread (172) and may further have a bushing (171). The inner thread is (172) is attached to the mounting hole (17). The bushing (171) is made of metal such as ion, is mounted in the mounting hole (17) and may have the inner thread formed in the bushing (171).

The angle limit (13) is formed on and protrudes up from the top of the base (10) adjacent to the front end and has an abutment wall (131). The abutment wall (13) faces backward and may be perpendicular to the bottom of the base (10).

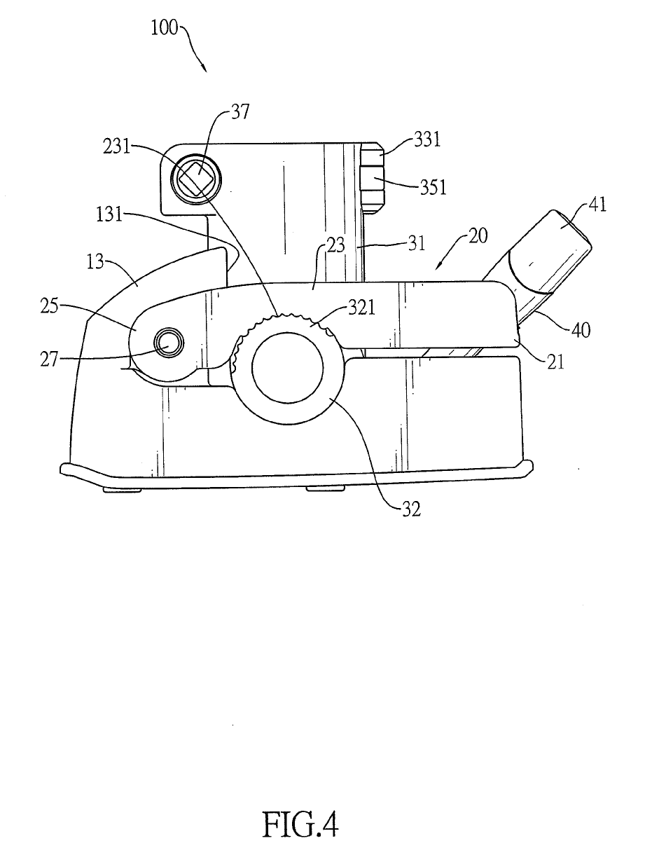

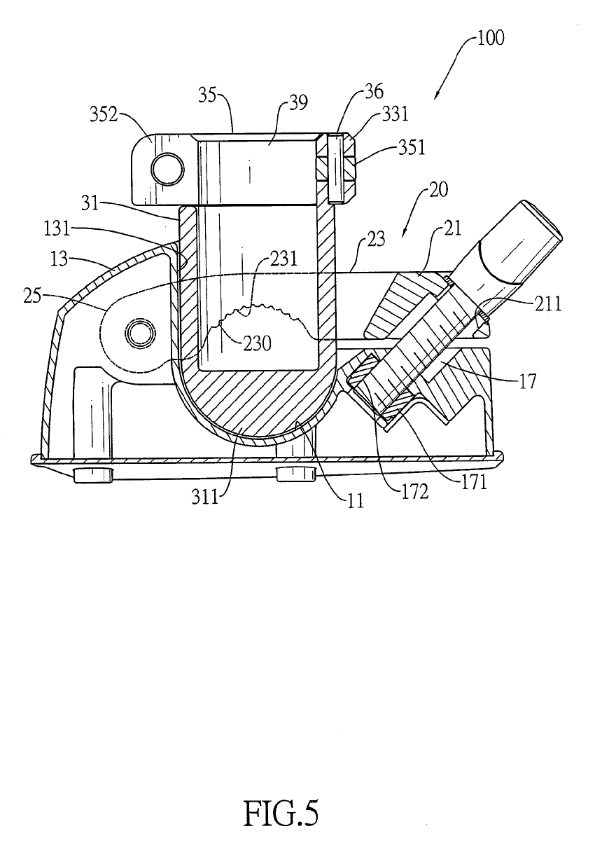

With further reference to FIGS. 4 and 5, the positioning clip (20) is U-shaped, is connected pivotally to the front end of the base (10) and has an intermediate section (21) and two arms (23).

The intermediate section (21) has a through hole (211) defined through the intermediate section (21) and is aligned with the mounting hole (17) in the base (10) when the positioning clip (20) is closed on the base (10). The intermediate section (21) has two ends.

The arms (23) are formed on and protrude forward respectively from the ends of the intermediate section (21) and correspond respectively to and are pivotally connected respectively to the pivot mounts (15) on the base (10) through two pivot pins (27). Each arm (23) has a bottom surface, an upper positioning notch (230) and a connecting end (25). The upper positioning notch (230) is curved, is defined in the bottom surface of the arm (23) and is aligned with one of the lower positioning notches (12) in the base (10) to form a positioning hole when the positioning clip (20) is closed on the base (10). The upper positioning notch (230) may have a frictional surface and multiple friction keyways (231) defined radially in the frictional surface. The connecting end (25) is connected pivotally to a corresponding pivot mount (15) on the front end of the base (10) and may have a pivot notch (251) and a pivot hole. The pivot notch (251) is defined longitudinally in the connecting end (25) and pivotally holds the corresponding pivot mount (15). The pivot hole is defined transversely through the connecting end (25). One of the pivot pins (27) extends through the pivot holes of the pivot mount (15) and the connecting end (25) to pivotally connect the arm (23) to the pivot mount (15).

The mounting sleeve (30) is mounted pivotally in the pivot recess (11) in the base (10), may selectively abut the abutment wall (131) of the angle limit (13) to stand uprightly on the base (10) and has a bottom end (311), a top end, two opposite sides, a fitting hole (39), two friction wheels (32) and may further have a clamp.

The bottom end (311) is curved to prevent the inner surface of the pivot recess (11) in the base (10) from wearing the bottom end (311).

The fitting hole (10) is defined in the top end and receives the supporting rod (70).

The friction wheels (32) are formed on and transversely protrude respectively from the sides of the mounting sleeve (30) and correspond respectively to the arms (23) of the positioning clip (20). The friction wheels (32) correspond respectively to and selectively and respectively engage the positioning holes formed by the lower and upper positioning notches (12, 230) to prevent the mounting sleeve (30) from inadvertently pivoting relative to the base (10). Each friction wheel (32) may have an annular outer surface and multiple friction keys (321). The friction keys (321) are formed radially on the annular outer surface and selectively engage and bite the friction keyways (231) in the upper positioning notch (230) of a corresponding positioning hole respectively. When the positioning clip (30) is closed on the base (10), the positioning holes contract and reduce to make the friction keyways (231) tightly engage the friction keys (321) respectively. The tight engagement of the friction keyways (231) and the friction keys (321) prevent the mounting sleeve (30) and the supporting rod (70) from inadvertently pivoting relative to the base (10) and the bass drum (90).

The clamp is attached to the top end of the mounting sleeve (30) around the fitting hole (39), may tightly clamp the supporting rod (70) and has a stationary clamping member (33), a movable clamping member (35), a bolt (37) and a nut (38).

The stationary clamping member (33) is curved, is formed on and protrudes up from the top end of the mounting sleeve (30) and has a connection end (331) and a fastening end (332) opposite to the connection end (331). The fastening end (332) has a through bore.

The movable clamping member (35) is connected pivotally to and selectively engages the stationary clamping member (33) to tightly clamp the supporting rod (70). The movable clamping member (35) has a connection end (351) and a fastening end (352). The connection end (351) of the movable clamping member (35) is connected pivotally to the connection end (331) of the stationary clamping member (33). The fastening end (352) of the movable clamping member (35) selectively engages the fastening end (332) of the stationary clamping member (33) to close the clamp and therefore to clamp the supporting rod (70). The fastening end (352) of the movable clamping member (35) has a through bore.

The bolt (37) is mounted through the through bores of the stationary and movable clamping members (33, 35).

The nut (38) is mounted detachably on the bolt (37) to hold the movable clamping member (35) on the stationary clamping member (33).

The adjusting knob is mounted detachably and rotatably through the through hole (211) of the positioning clip (20) in the mounting hole (17) of the base (10) and has an adjusting bolt (40) and a knob member (41).

The adjusting bolt (40) is mounted detachably and rotatably through the through hole (211) of the positioning clip (20) in the mounting hole (17) of the base (10) and may be mounted in the bushing (171). The adjusting bolt (40) has an outside end and an outer thread engaging the inner thread (172) in the mounting hole (17) of the base (10).

The knob member (41) is mounted on the outside end of the adjusting bolt (40) and selectively presses against the intermediate section (21) of the positioning clip (20) to tightly hold the positioning clip (20) closed on the base (10). The knob member (41) allows a user to easily rotate the adjusting bolt (40) through the knob member (41).

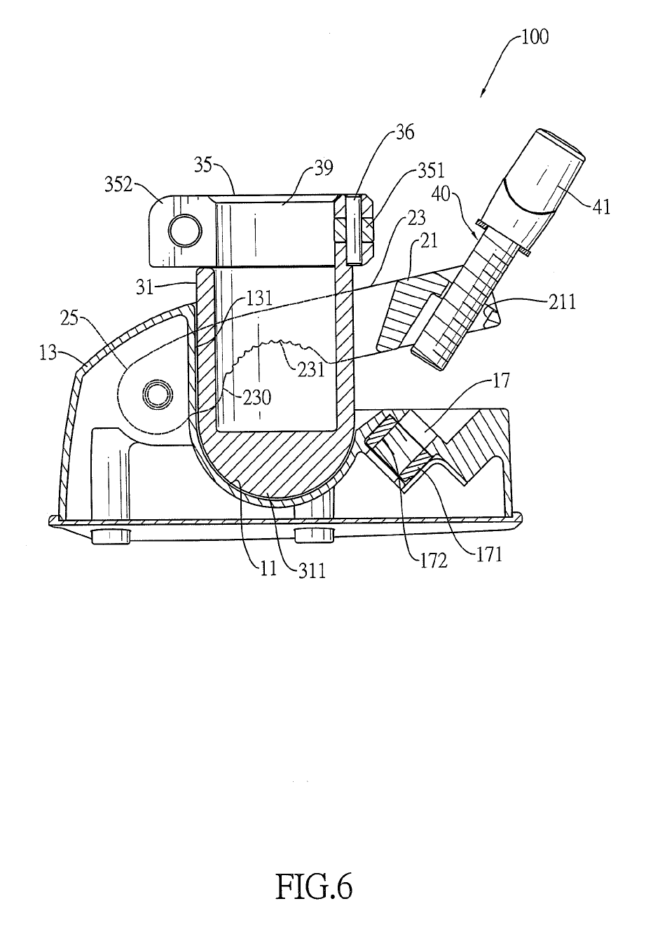

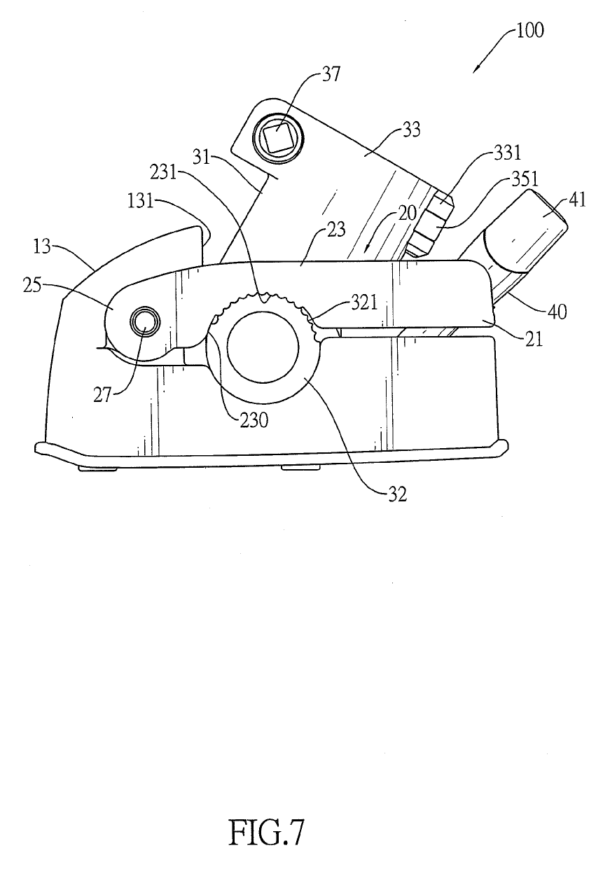

With further reference to FIGS. 6 and 7, to pivot the supporting rod (70) on the adjustable holding device (100), the adjusting knob is rotated to release the positioning clip (20) to enlarge the positioning holes formed by the lower and upper positioning notches (12, 230). The friction wheels (32) disengage from the enlarged positioning holes to allow the mounting sleeve (30) to pivot on the base (10) to a specific angular position. The adjusting knob rotated reversely to tightly press the positioning clip (20) against the base (10). The positioning holes are contracted to tightly engage the friction wheels (32) to prevent the mounting sleeve (30) from inadvertently pivoting.

The adjustable holding device can adjust the angular position of the supporting rod (70). Therefore, a beater to play the drums on the supporting rod (70) may adjust supporting rod (70) to an appropriate angular position and a level without tilting his/her body.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An adjustable holding device comprising:
a base having
a front end;
a rear end;
two opposite sides;
a top;
a bottom;
two lower positioning notches being curved and defined in the top of the base adjacent respectively to the sides;
a pivot recess being curved and defined in the top of the base between the lower positioning notches and having an inner surface being curved; and
a mounting hole defined in the top of the base near the rear end and having an inner thread;
a positioning clip being U-shaped, connected pivotally to the front end of the base and having
an intermediate section having a through hole defined through the intermediate section and aligned with the mounting hole in the base when the positioning clip is closed on the base, and the intermediate section having two ends; and
two arms formed on and protruding forward respectively from the ends of the intermediate section and corresponding respectively to and pivotally connected respectively to the pivot mounts on the base through the pivot pins, and each arm having
a bottom surface;
an upper positioning notch being curved, defined in the bottom surface of the arm and aligned with one of the lower positioning notches in the base to form a positioning hole when the positioning clip is closed on the base; and
a connecting end connected pivotally to the front end of the base;
a mounting sleeve mounted pivotally in the pivot recess in the base and having
a bottom end being curved;
a top end;
two opposite sides;
a fitting hole defined in the top end; and
two friction wheels formed on and transversely protruding respectively from the sides of the mounting sleeve, corresponding respectively to the arms of the positioning clip and corresponding respectively to and selectively and respectively engaging the positioning holes; and
an adjusting knob mounted detachably and rotatably through the through hole of the positioning clip in the mounting hole of the base and having
an adjusting bolt mounted detachably and rotatably through the through hole of the positioning clip in the mounting hole of the base and having an outside end and an outer thread engaging the inner thread in the mounting hole of the base; and
a knob member mounted on the outside end of the adjusting bolt and selectively pressing against the intermediate section of the positioning clip.

2. The adjustable holding device as claimed in claim 1, wherein:
each upper positioning notch of the positioning clip has a friction surface and multiple friction keyways defined radially in the frictional surface; and
each friction wheel of the mounting sleeve has an annular outer surface and multiple friction keys formed radially on the annular outer surface and selectively engaging the friction keyways in the upper positioning notch of a corresponding positioning hole respectively.

3. The adjustable holding device as claimed in claim 2, wherein the base further has an angle limit formed on and protruding up from the top of the base adjacent to the front end and having an abutment wall facing backward and selectively abutting the mounting sleeve.

4. The adjustable holding device as claimed in claim 3, wherein the abutment wall of the angle limit is perpendicular to the bottom of the base.

5. The adjustable holding device as claimed in claim 4, wherein the mounting sleeve further has a clamp attached to the top end of the mounting sleeve around the fitting hole and having
a stationary clamping member being curved, formed on and protruding up from the top end of the mounting sleeve and having a connection end and a fastening end having a through bore;
a movable clamping member connected pivotally to and selectively engaging the stationary clamping member and having
a connection end connected pivotally to the connection end of the stationary clamping member; and
a fastening end selectively engaging the fastening end of the stationary clamping member to close the clamp and having a through bore;
a bolt mounted through the through bores of the stationary and movable clamping members; and
a nut mounted detachably on the bolt to hold the movable clamping member on the stationary clamping member.

6. The adjustable holding device as claimed in claim 5, wherein:
the base further has two pivot mounts formed on the top of the base adjacent respectively to the sides and near the front end and each pivot mount has a pivot hole defined through the pivot mount; and
the arms of the positioning clip correspond respectively to and are pivotally connected respectively to the pivot mounts and the connecting end of each arm has
a pivot notch defined longitudinally in the connecting end and pivotally holding a corresponding pivot mounts;
a pivot hole defined transversely through the connecting end; and
a pivot pin extends through the pivot holes of the corresponding pivot mount and the connecting end.
